(19) United States
(12) Patent Application Publication
(10) Pub. No.: US 2003/0065493 A1
(43) Pub. Date: Apr. 3, 2003

(54) Method for determining periodically stationary solutions for a technical system

(76) Inventors: Rolf Neubert, Unterhaching (DE); Angela Schwarz, Puchheim (DE)

Correspondence Address: LERNER AND GREENBERG, P.A., Post Office Box 2480, Hollywood, FL, 33022-2480, US

(21) Appl. No.: 10/262,118

(22) Filed: Oct. 1, 2002

(30) Foreign Application Priority Data
Oct. 1, 2001 (DE) 101 48 542.5

(51) Int. Cl. G06F 7/60; G06F 17/10

(52) U.S. Cl. 703/2

(57) ABSTRACT

A technical system is defined by a system of differential algebraic equations, and has periodically stationary solutions. The periodically stationary solutions are defined by setting up a homotopy equation which links a fixed point equation to a trivial equation, and by following a solution path of the homotopy equation from a start point to a target point by successively determining points of the homotopy equation.

### BACKGROUND OF THE INVENTION

Field of the Invention

Statements relating to the behavior of technical systems which are subject to oscillations in various states are required increasingly frequently in engineering. Technical systems such as these include electrical circuits, in particular phase locked loops or phase locked loop circuits and switched capacitor circuits. These technical systems are described by highly complex differential algebraic equation systems.

It is particularly important to define periodically stationary states in order to make statements relating to such technical systems and/or to describe the states of such technical systems with respect to time.

A number of direct methods for determining periodically stationary states of such technical systems are known from the prior art. These include, in particular, the shooting method and the method of harmonic balance.

However, all of these methods are only locally convergent. Accordingly, these methods give only one solution if the start value is located in the vicinity of the desired solution or the convergence range is very wide. In many practical applications, especially in the case of phase locked loops and in the case of switched capacitor circuits, these preconditions are not satisfied. Since these methods do not converge, it is often impossible to calculate periodically stationary states using these methods.

Furthermore, indirect methods are known from the prior art for determining periodically stationary states of such technical systems. These indirect methods are used when it is impossible to calculate periodically stationary states using the direct methods. The indirect methods for determining periodically stationary states simulate the relevant technical system in the time domain until it reaches the steady state.

The indirect methods for determining periodically stationary states have the disadvantage that they are considerably inferior to the direct methods with regard to computation time, memory space and reliability. A further disadvantage is that, in many relatively extensive applications, in particular in the case where time constants with major differences occur, the indirect methods do not allow periodically stationary states to be calculated, for complexity reasons.

By way of example, in the case of a phase locked loop having an oscillator whose frequency is 1 GHz and which has a period of 1 ns, and a stabilization time of approximately 1 ms. Thus, in this case, it is necessary to simulate 10⁶ periods before the steady state is reached. In this case, no solution can be determined by means of an indirect method for determining periodically stationary states, for complexity reasons.

### SUMMARY OF THE INVENTION

It is accordingly an object of the invention to provide a method of determining periodically stationary solutions of a technical system which overcomes the above-mentioned disadvantages of the heretofore-known devices and methods of this general type, wherein the technical system may have any given complexity and any given size, and wherein the method is precise independently of chosen start values, and independently of the convergence range of the technical system.

With the foregoing and other objects in view there is provided, in accordance with the invention, a method for determining periodically stationary solutions for a technical system that is subject to oscillations. According to one precondition of the invention, the conditional equations of a technical system are defined by a system of differential algebraic equations in the form f(x′,x,t)=0. Furthermore, a periodic solution x of this system of differential algebraic equations with the period T satisfies the periodic boundary conditions: x(0)=x(T).

In a first step of the method according to the invention, a fixed point equation is set up in the form:

x=φ(T;x) or F(x)=x−φ(T; x)=0.

In this case, φ(T;x₀) is a solution of the system of differential algebraic equations at the time t with the start value x₀. Thus, φ(0;x₀)=x₀.

In a further step, a trivial equation is set up in the form: G(x)=x−a=0. In a next step, the solution of the fixed point equation F(x)=0 is embedded in a homotopy equation, which is extended by a parameter λ, in the form:

η(x,λ;a)=(1−λ)G(x)+λF(x)=(1−λ)(x−a)+λ(x−φ(T;x))=x−(λφ(T;x)+(1−λ))a)=0.

A suitable start value a is selected in a next step. One solution path of the solutions of the homotopy equation η(x,λ;a)=0 is then followed. This is based on a start point Pₛₜₐᵣₜ(λ,x) where λ=0,x=a. A new point P(λ,x) where 0<=λ<=1 is then in each case determined for the homotopy equation. In this case, the procedure starts from the start point Pₛₜₐᵣₜ(0,a) or from the most recently determined point or points P(λ,x). The process of determining a new point P(λ,x) where 0<=λ<=1 is in each case continued until the desired target point P_{target}(1,x) is reached.

The basic idea of the globally convergent method according to the invention for determining periodically stationary states in a technical system is to link a problem which is difficult to solve, in particular a fixed point equation F(x)=0, with a problem which is easy to solve, in particular with a trivial equation G(x)=x−a=0.

This linking process is preferably carried out by additively connecting the fixed point equation F(x), weighted by the factor λ, and the trivial equation G(x), weighted by the factor (1−λ), and setting them equal to 0.

The solution to the problem that is difficult to solve, in particular the fixed point equation F(x)=0, is achieved, according to this basic idea of the invention, by starting from the problem which is easy to solve, in particular from the trivial equation G(x)=0. At this point, the homotopy equation is the parameter λ=0.

The parameter λ is then varied in steps, and one or more new points of the homotopy equation η(x,λ;a) is or are in each case calculated from the respective most recently determined point or points of the homotopy equation and from the respectively newly selected parameter λ.

Finally, this results in the solution of the difficult problem, in particular of the fixed point equation F(x)=0 with the parameter λ=1.

Accordingly, a configured family of solutions exists, which connects the solution of the simple problem, in particular of the trivial equation G(x)=0, to the solution of the original problem, in particular of the fixed point equation F(x)=0. On the basis of the problem that is simple to solve, the solution curve or the solution path is followed which, in the end, produces the solution to the original problem.

This method for determining periodically stationary states in technical systems is advantageously globally convergent, and can thus be used without restriction even for technical systems with a small convergence range and/or with a highly non-linear relationship between the solution and the initial value. Furthermore, this method according to the invention is optimum in terms of speed, and is extremely reliable.

According to one embodiment of the invention, a suitable continuation method is chosen for determining new points P(λ,x) where 0<=λ<=1 from the homotopy equation η(x,λ;a)=0. This makes use of the fact that points P(λ,x) where 0<=<=1 are determined, which do not represent an exact solution but only good approximations to the solutions to the homotopy equation.

The precise solutions to the homotopy equation p(x,λ;a)=0 are determined from these determined approximations. In this case, iterative methods are used for direct solution, which are based on the purely locally convergent Newton method. Methods such as these are known to those skilled in the art. See, for example, Telichevesky, Kundert, El-Fadel, and White, in “Fast Simulation Algorithms for RF Circuits,” Proceedings of the 1996 IEEE Custom Integrated Circuits Conference, San Diego, USA, May 1996, IEEE, pp. 437-44

This procedure according to the invention ensures that the determined approximations are in the vicinity of the exact solution. The locally convergent iterative methods are thus suitable for determining the exact solutions to the homotopy equation.

The above steps in the method according to the invention result in very good starting approximations. This therefore takes account of the restriction relating to local convergence. Successive use of the locally convergent methods thus in a particularly advantageous manner result, overall, in a globally convergent method for determining periodically stationary solutions for a technical system.

According to a further embodiment of the invention, a predictor-corrector method is used as a continuation method for determining new points for the homotopy equation.

In this case, a predictor x* is determined for the respective point P(λ,x) where 0<=λ<=1 from the start point Pₛₜₐᵣₜ(0,a) and/or from the most recently determined point or points P(λ,x). With suitable step width control, the predictor x* is a good approximation to the solution of the homotopy equation p(x,λ;a)=0 for a fixed parameter λ.

The homotopy equation:

η(x, λ;a)=x−(λφ(T;x*)+(1−λ)a)=0

which is obtained by substitution of the predictor x* can be solved by means of a locally convergent shooting method, in particular by means of an extended shooting method.

Accordingly, a point P(λ,x) where 0<=λ<=1 can be determined exactly by using the good approximation to the predictor x*.

In this embodiment of the invention, the solution to the configured homotopy equation η(x,λ;a)=0 can be calculated efficiently by the use of continuation methods. In this case, a locally convergent shooting method is used in each case to solve each point to be calculated for the homotopy equation.

The sought solution of the fixed point equation F(x)=0 on which the homotopy equation p(x,λ;a)=0 is based can be determined in a particularly advantageous manner in this way.

According to a further embodiment of the invention, suitable configuration of the solution path can be provided by the step width λ. Control of the step width λ allows the method according to the invention to be particularly advantageously matched to the complexity of the given technical system. Appropriate choice of the configuration by means of the step width λ ensures that the solutions to the fixed point equation on which the homotopy equation is based can be determined particularly reliably.

According to a further embodiment of the invention, the method according to the invention for determining periodically stationary solutions can also be applied to a technical system which has at least one electrical circuit.

The invention furthermore relates to the use of the method according to the invention for simulation of electrical circuits, in particular of phase locked loops as well as switched capacitor circuits. Integrated electrical circuits, in particular phase locked loops as well as switched capacitor circuits, are particularly suitable for carrying out the method for determining periodically stationary solutions.

The invention is also implemented in a computer program for carrying out a method for determining periodically stationary solutions for technical systems. The computer program is in this case designed such that a method based on one of the claims according to the invention is implemented on the basis of inputting the technical system by means of a system of differential algebraic equations. In this case, a number of periodically stationary solutions of the system of differential algebraic equations are output as the result of the method. These periodically stationary solutions highly advantageously make it possible to make statements relating to the technical system on which this is based, in particular relating to the electrical circuit on which this is based.

The computer program as improved according to the invention results in reliable and complete determination of the periodically stationary solutions and an improvement in the delay time in comparison to the known methods for determining periodically stationary solutions for technical systems.

With the above and other objects in view there is also provided, in accordance with the invention, a computer program which is contained in a memory medium stored in a computer memory, which is contained in a direct access memory, or which is transmitted on an electrical carrier signal. The invention furthermore relates to a data storage medium having such a computer program and to a method wherein such a computer program is downloaded from an electronic data network, for example from the Internet, to a computer which is connected to the data network.

Other features which are considered as characteristic for the invention are set forth in the appended claims.

Although the invention is illustrated and described herein as embodied in a method for determining periodically stationary solutions for a technical system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flowchart illustrating the procedure of the method for determining periodically stationary solutions for a technical system which has oscillations;

FIG. 2 is a schematic illustration of a phase locked loop with a phase comparison, a low-pass filter, with a voltage controlled oscillator, and with a divider according to one exemplary embodiment;

FIG. 3 is a chart illustrating a generic homotopy equation solution representation with a first solution path; and

FIG. 4 is a graph of a specific homotopy equation solution representation for the phased locked loop shown in FIG. 2, with a second solution path and with a third solution path, according to the exemplary embodiment.

### DESCRIPTION OF THE PREFERRED EMBODIMENTS

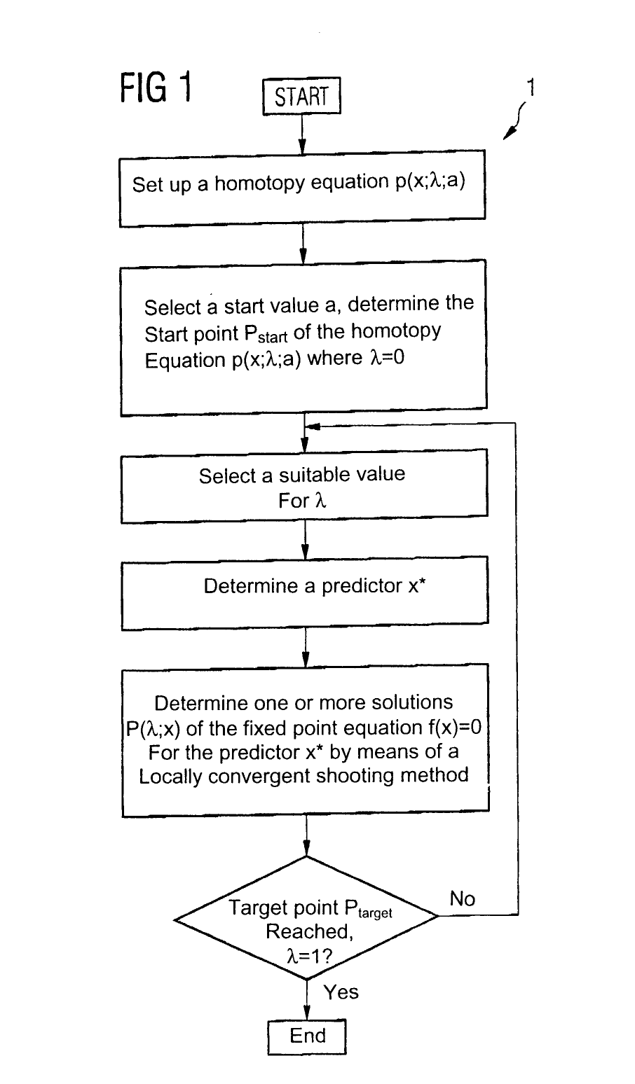

Referring now to the figures of the drawing in detail and first, particularly, to FIG. 1 thereof, there is shown a flowchart 1 illustrating the procedure of the method for determining periodically stationary solutions for a technical system that is subject to oscillations.

The method according to the invention is based on a technical system, in particular an electronic circuit, which is described by a system of differential algebraic equations in the form f(x′,x,T)=0. This system of differential algebraic equations has a set of periodic solutions x of period T, which satisfy the periodic boundary conditions x(0)=x(T).

A solution of the system of differential algebraic equations φ(t;x₀) is now chosen, which has the time t and the start value x₀. This thus results in the equation:

φ(0;x₀)=x₀.

The fixed point equation x=φ(T;x) is now derived from the period boundary conditions x(0)=x(T). The fixed point equation can also be described in the form f(x)=x−φ(T;x)=0. This fixed point equation is solved by means of so-called shooting methods. However, these shooting methods are only locally convergent and are thus dependent on choosing a start value in the immediate vicinity of the actual solution.

A trivial equation G(x)=m−a=0 is then set up. This trivial equation represents a problem which is easy to solve, and which contains a parameter a.

In a first step of the flowchart, as illustrated in FIG. 1, of the method according to the invention, a homotopy equation p(x;λ;a)=0 is set up. This homotopy equation links the fixed point equation F(x)=0, which is difficult to solve, to the trivial equation G(x)=0. In this case, the fixed point equation is weighted by the parameter λ, and the trivial equation is weighted by the parameter 1−λ. The fixed point equation weighted in this way and the trivial equation weighted in this way are additively connected, and are set to zero. This results in the homotopy equation, as follows:

η(x,λ;a)=(1−λ)G(x)+λF(x)=(1−λ) (x−a)+λ(x−φ(T;x))=x−(λφ(T; x)+(1−λ)a)=0.

In a next step of the method according to the invention, a start value a is chosen, and a start point Pₛₜₐᵣₜ=(0, a) is defined. This start point P_{Start} is calculated from the homotopy equation, with the parameter λ=0 being chosen.

The solution to the homotopy equation η(x,λ;a)=0 is thus identical to the solution to the trivial equation G(x)=x−a. The solution to the homotopy equation η(x,0;a)=0 can thus easily be determined in a corresponding manner.

In a next step of the method according to the invention, a suitable value is chosen for the parameter λ. In this case, the parameter λ is preferably incremented by a specific value, by means of a predetermined step width control.

In a next step of the method according to the invention, a predictor x* is determined, which gives a good approximation to the fixed point equation, with suitable step width control of the parameter λ, as follows:

f(x)=x=η(T;x)=x−(λη(T;x*)+(1−λ)a)=0

One or more solutions P(λ;x) to the fixed point equation F(x)=0 are then determined. In this case, the good initial approximation to the predictor x* is used as the basis of a locally convergent shooting method, in particular an extended standard shooting method, in order to determine the periodically stationary solutions. Shooting methods such as these are known to those skilled in the art.

A check is carried out at this point to determine whether the target point P_{target}(1, x*) has been reached. This is the case when the parameter λ assumes the value 1.

If the parameter λ has not yet reached the value 1, then the steps of choosing a suitable value for λ, determining a predictor x* and determining one or more solutions P(λ;x) of the fixed point equation F(x)=0 for the predictor x* by means of a locally convergent shooting method are repeated. These steps are repeated until the parameter λ assumes the value 1, and the target point P_{target} has thus been reached.

A solution to the fixed point equation F(x)=0 on which the homotopy equation η(x, λ;a)=0 is based is found at the target point P_{target}.

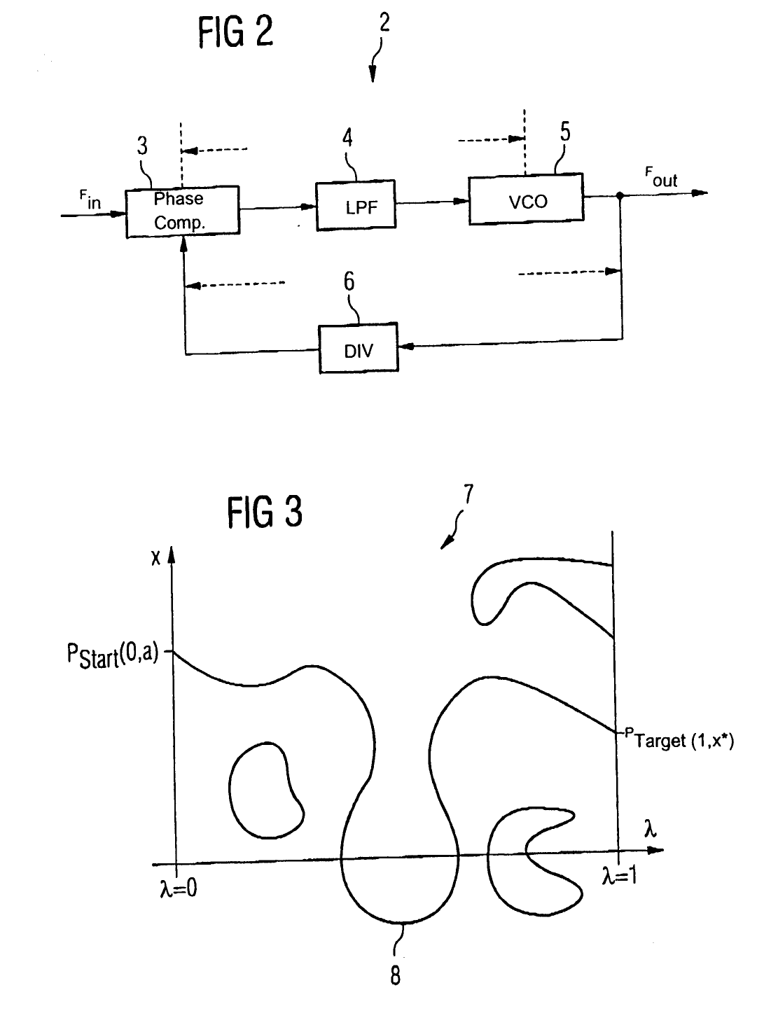

FIG. 2 shows a schematic illustration of a phase locked loop 2 with phase comparison 3, with a low-pass filter 4, with a voltage controlled oscillator 5 and with a divider 6 according to one exemplary embodiment.

The phase comparison 3, the low-pass filer 4 and the voltage controlled oscillator 5 of the phase locked loop 2, or of the phase locked loop circuit, are connected in series. The phase comparison 3 is fed with a reference frequency, which is represented by Fᵢₙ in FIG. 2, and with the output frequency Fₒᵤₜ of the voltage controlled oscillator 5, which is passed through the divider 6.

The path, as illustrated by dashed arrows in FIG. 2, between the phase comparison 3 and the voltage controlled oscillator 5 is referred to as the forward path. The path which is represented by dashed arrows between the output frequency of the voltage controlled oscillator 5 and the phase comparison 3 is referred to as the backward path.

The phase comparison 3 continuously compares the reference frequency Fᵢₙ with the output frequency Fₒᵤₜ in terms of phase and frequency. Discrepancies result in an error voltage at the output of the phase comparison 3, which is proportional to the phase difference between the reference frequency Fᵢₙ and the output frequency Fₒᵤₜ. The voltage controlled oscillator 5 is readjusted via the time constant of the low-pass filter 4, which acts as a loop filter, until the difference between the reference frequency Fᵢₙ and the output frequency Fₒᵤₜ becomes ever smaller. Finally, the voltage controlled oscillator 4 locks in at the reference frequency Fᵢₙ. Such phase locked loops 2, or phased locked loop circuits, generally have a relatively slow transient response.

The phase locked loop 2 can be described by an equation system having 277 differential algebraic equations in the form f(x′,x,t)=0 and by 112 MOSFETs (metal oxide semiconductor field-effect transistors). For clarity reasons, this highly extensive and very complex system of differential equations will not be described at this point.

FIG. 3 shows a generic homotopy equation solution representation 7 with a first solution path 8.

The generic homotopy equation solution representation 7 illustrates a first solution path 8 of the method according to the invention.

The first solution path 8 represents a two-dimensional graphical representation of the solution of an example of a homotopy equation η(x,λ;a)=0 of a differential algebraic equation system in the form f(x′,x,t).

The parameter λ is shown in the horizontal direction of the generic homotopy equation solution representation 7, and the variable x is shown in the vertical direction.

The parameter λ assumes the value zero on the vertical x-axis, which bounds the generic homotopy equation solution representation 7 on the left-hand side. The start point Pₛₜₐᵣₜ(0,a) is arranged on this axis. The value of the parameter λ=1 on the vertical axis, which runs parallel to the x-axis and bounds the generic homotopy equation solution representation 7 on the right-hand side. The target point P_{target}(1,x*) is contained on this axis.

The first solution path 8 forms a connection between the start point Pₛₜₐᵣₜ(0,a) and the target point P_{target}(1,x*) and includes a set of solutions to the homotopy equation η(x,λ;a)=0. The other three form elements illustrated in FIG. 3 each represent a further solution set to the homotopy equation, but these do not form a solution path.

The individual method steps according to the invention for determining the first solution path 8 and for determining the solution of the homotopy equation η(x,λ;a)=0 as well as the solution of the differential algebraic equation system f(x′,x,t)=0 are not illustrated in detail here, for reasons of clarity.

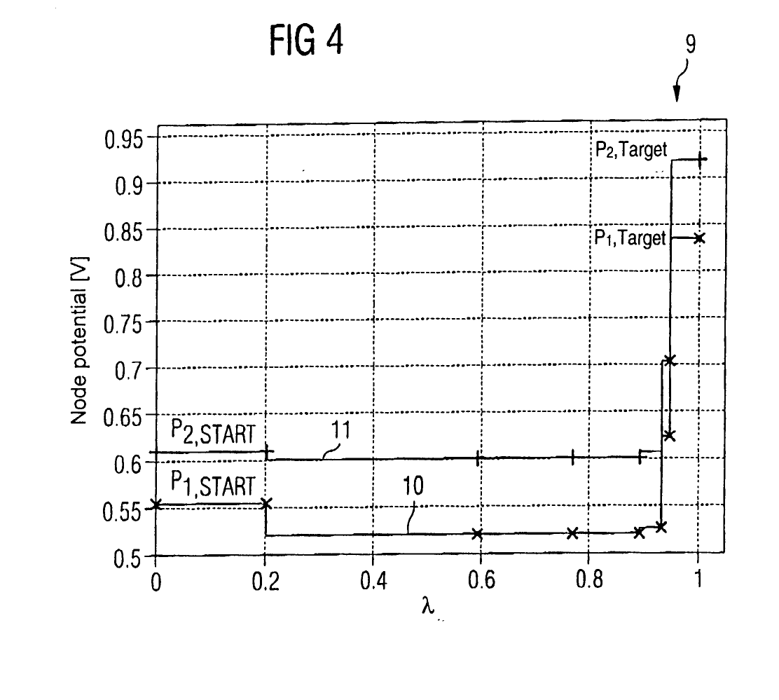

FIG. 4 contains an exemplary illustration of the method steps according to the invention, for the phase locked loop 2 shown in FIG. 2.

FIG. 4 shows a specific homotopy equation solution representation 9 for the phase locked loop 2 which is illustrated in FIG. 2, with a first solution path 10 and with a third solution path 11 according to the exemplary embodiment.

The specific homotopy equation solution representation 9 is a two-dimensional graphical representation of the solution of a highly extensive and very complex homotopy equation η(x,λ;a)=0, which is not mentioned here explicitly for reasons of clarity, of the differential algebraic equation system in the form f(x′,x,t)=0 which describes the phase locked loop 2.

The parameter λ is shown in the horizontal direction of the specific homotopy equation solution representation 9 in FIG. 4, and the node potential [V] is shown in the vertical direction.

The second solution path 10 forms a connection between a first start point P_{1,start}(λ=0;V=0.55) and a first target point P_{1.target}(λ=1,V=0.83). The third solution path 11 forms a connection between a second start point P_{2,start}(λ=0;V=0.61) and a second target point P_{2,target}(λ=1,V=0.91). The second solution path 10 and the third solution path 11 each have a set of solutions to the homotopy equation η(x,λ;a)=0.

The specific homotopy equation system representation 9 of the phase locked loop 2 was produced by the method, as shown in FIG. 1, for determining periodically stationary solutions for a technical system which has oscillations.

When determining periodically stationary solutions for the phase locked loop 2 as shown in FIG. 2, a fixed point equation in the form f(x)=x−φ(t;X)=0 is set up on the basis of the equation system in the form f(x′,x,t), for which φ(T;x₀) represents a solution at the time t with the start value x₀. The determination of a fixed point equation such as this is known to those skilled in the art.

An easily solvable trivial equation in the form G(x)=x−a=0 is then set up for the phase locked loop 2. The determination of a trivial equation such as this is known to those skilled in the art.

The homotopy equation:

η(x,λ;a)=(1−λ)G(x)+λF(x)=0

is set up in a next step, and is obtained by linking the equations F(x) and G(x) weighted by the parameter λ. The process of setting up homotopy equations is described by L. T. Watson, “A Globally Convergent Algorithm for Computing Fixed Points of C2 Maps,” Applied Mathematics and Computation, 5 (1979), pages 297-311.

A suitable start value is then chosen for the parameter a.

The first start point P_{1,start}(λ=0;V=0.55) is now determined for a first node voltage V₁ of the phase locked loop 2, and the second start point P_{2,start}(λ=0;V=0.61) of the homotopy equation η(x,λ;a)=0 is determined for a second node voltage V₂ of the phase locked loop 2, using this start value for the parameter a and using the value “0” for the parameter λ.

The value of the parameter λ is then increased and, based on the first start point P_{1,start}(λ=0;V=0.55), a predictor x* is determined for the new value of the parameter λ, which represents a good approximation of the fixed point equation F(x)=0 on which this is based. The predictor x* thus provides a good initial approximation for the point P(λ,x), which is located exactly on the second solution path 10 for the new value of λ.

Based on the second start point P_{2,start}(λ=0;V=0.61), the value of the parameter λ is likewise increased in order to determine a predictor x*, which represents a good initial approximation for the point P(λ,x), which is located exactly on the third solution path 11, for the value of λ.

Now, based on the respective predictor x* and by means of a locally convergent shooting method, a point which is located on the second solution path 10 and a point which is located on the third solution path 11 in the homotopy equation η(x,λ;a)=0 can be calculated as a start value.

Shooting methods such as these are described by Telichevesky, Kundert, El-Fadel, and White, in “Fast Simulation Algorithms for RF Circuits,” Proceedings of the 1996 IEEE Custom Integrated Circuits Conference, San Diego, USA, May 1996, IEEE, pp. 437-44.

The parameter λ is then increased further, and a new predictor x* is in each case produced from the respective previously produced point or points P(λ,x) of the second solution path 10 and of the third solution path 11, respectively. Using these predictors, new points P(λ,x) for the second solution path 10 and for the third solution path 11 are calculated by means of locally convergent shooting methods.

Successive new points of the homotopy equation η(x,λ;a)=0 are then determined along the second solution path 10 and along the third solution path 11 by choosing new values for the parameter λ, by determining new predictors x* from the previously determined points from the homotopy equation using the respective new value for the parameter λ, and, using a locally convergent shooting method, by calculating exact solutions to the homotopy equation η(x,λ;a)=0 from these predictors.

The shooting methods used in this case are described by Allgower and Georg in “Introduction to Numerical Continuation Methods,” Springer, New York, 1990.

The method according to the invention is complete when the parameter λ assumes the value 1. At this point, the solution to the homotopy equation η(x,λ;a)=0 has been found. This solution matches the solution to the fixed point equation F(x)=0.

In the specific homotopy equation solution representation 9 in FIG. 4, these solutions are the target points

P_{1.target}(λ=1,V=0.83) and P_{2.target}(λ=1,V=0.91)

These target points respectively represent one solution of the homotopy equation η(x,λ;a)=0 and one solution of the fixed point equation F(x)=0 on which it is based.

The solution of the homotopy equation η(x,λ;a)=0 with the value “1” for the parameter λ results in a solution for the system of the differential algebraic equations: f(x′,x,t) 0, which describes the phase locked loop 2.

The determination of such a solution of the system of differential algebraic equations f(x′,x,t)=0 is known to those skilled in the art.

We claim:

1. A method for determining periodically stationary solutions for a technical system subject to oscillations, wherein:
the technical system is defined with a system of differential algebraic equations in the form:
f(x′,x,t)=0
wherein a periodically stationary solution x of period T represents one solution of the system of the differential algebraic equations and satisfies periodic boundary conditions:
x(0)=x(T)
and wherein the method comprises the following steps: setting up a fixed point equation in the form:
F(x)=x−φ(T;x)=0,
wherein φ(T;x₀) represents a solution of the differential algebraic equation at a time t with the start value x₀;
setting up a trivial equation in the form:
G(x)=x−a=0;
setting up a homotopy equation in the form:
η(x,λ;a)=(1−λ)G(x)+λF(x)=(1−λ)(x−a)+λ(x−φ(T;x))=(λφ(T;x)+(1−λ)a)=0;
selecting a suitable start value a; and
following one solution path of the homotopy equation η(x,λ;a), starting from a start point Pₛₜₐᵣₜ(λ,x), with λ=0, x=a in the homotopy equation η(x,λ;a), thereby determining successive new points P(λ,x), with 0>λ>1, of the homotopy equation η(x,λ;a) until a desired target point P_{target}(λ,x) with X=1 is reached, and thereby determining new points P(λ,x) of the homotopy equation η(x,λ;a) with 0>λ>1 using one of the start point Pₛₜₐᵣₜ(λ,x) and at least one most recently determined point P(λ,x); and
determining therefrom periodically stationary solutions for the technical system.

2. The method according to claim 1, wherein the step of following one solution path comprises choosing a suitable continuation method for determining the new points P(λ,x), with 0≦λ≦1, of the homotopy equation η(x,λ;a)=0.

3. The method according to claim 1, wherein the step of determining new points of the homotopy equation η(x,λ;a)=0 comprises determining a predictor x* from the start point Pₛₜₐᵣₜ (λ;x), with λ=0, x=a, and from at least one most recently determined point P(λ,x), wherein, by suitable control of a step width λ, the predictor x* gives a good approximation to the solution of the homotopy equation for a fixed λ:
η(x,λ;a)=x−(λφ(T;x*)+(1−λ)a)=0;
solving the homotopy equation having the predictor x* with a locally convergent shooting method, and wherein a solution of the homotopy equation thus determined provides a new point P(λ,x), with 0≦λ≦1 for the solution path of the homotopy equation.

4. The method according to claim 3, which comprises solving the homotopy equation having the predictor x* with an extended shooting method.

5. The method according to claim 3, which comprises providing a suitable configuration of the solution path by the step width λ.

6. The method according to claim 1, wherein the technical system has at least one electrical circuit, and the method comprises determining a behavior of the electrical circuit.

7. The method according to claim 1, wherein the technical system includes an electrical circuit, and the method is performed to simulate a behavior of the electrical circuit.

8. A computer program product with computer-executable instructions for performing the method according to claim 1 for determining periodically stationary solutions for a technical system subject to oscillations.

9. A computer-readable medium containing computer-executable instructions for performing the method according to claim 1, wherein the computer-executable instructions are contained in a memory medium.

10. A computer-readable medium containing computer-executable instructions for performing the method according to claim 1, wherein the computer-executable instructions are contained in a computer memory.

11. A computer-readable medium containing computer-executable instructions for performing the method according to claim 1, wherein the computer-executable instructions are contained in a direct access memory.

12. A computer-readable medium containing computer-executable instructions for performing the method according to claim 1, wherein the computer-executable instructions are transmitted on an electrical carrier signal.

13. A data storage medium containing a computer program product with computer-executable instructions for performing the method according to claim 1 for determining periodically stationary solutions for a technical system subject to oscillations.

14. A computer-related method, which comprises downloading a computer program product with computer-executable instructions for performing the method according to claim 1 from an electronic data network, to a computer connected to the data network.

15. The method according to claim 14, wherein the data network is the Internet.
